(19) United States
(12) Patent Application Publication
(10) Pub. No.: US 2013/0047100 A1
(43) Pub. Date: Feb. 21, 2013

(54) Link Disambiguation For Touch Screens

(71) Applicants: Robert Kroeger, Kitchener (CA); Ian Chadwyck Faragher, Kitchener (CA); Fady Samuel, Kitchener (CA)

(72) Inventors: Robert Kroeger, Kitchener (CA); Ian Chadwyck Faragher, Kitchener (CA); Fady Samuel, Kitchener (CA)

(73) Assignee: Google Inc., Mountain View, CA (US)

(21) Appl. No.: 13/211,974

(22) Filed: Aug. 17, 2011

(51) Int. Cl. G06F 3/048

(52) U.S. Cl. 715/760

(57) ABSTRACT

Methods, systems and computer program products for displaying links on a touch screen are disclosed. A link area of uncertainty at a touch point of a touch screen gesture may be determined. Two or more links may be determined at the link area. A predicted link of the two or more links may be selected. An enlarged display of the predicted link may be previewed. A system for displaying links on a touch screen may include a link area determiner, a link selector and a link previewer.

### TECHNICAL FIELD

The embodiments relate generally to displaying, selecting or following links on a touch screen.

### BACKGROUND

Improvements in technology have led to the creation of smaller and more portable electronic devices. Not only have devices become smaller and more portable, but many devices have begun to implement touch screen technology, allowing a user to literally touch the screen of the device to make selections (e.g., rather than requiring the use of a stylus or other device). Touch screen devices allow users to perform any of a variety of functions including, but not limited to, drawing images, typing on an onscreen keyboard and activating links. However, these smaller touch screen devices often render smaller images and text which may make it difficult for a user who desires to interact with these smaller renderings of text and images to specifically select those images or specific text the user desires to activate from the touch screen.

### BRIEF SUMMARY

Methods and systems for displaying links on a touch screen are disclosed herein. Links may include hyperlinks, links to another web page or portion of a web page, reference links, or any other text or representation that opens or leads to a separate text, video, document or other media. A system and method for displaying links on a touch screen is disclosed. A link area of uncertainty at a touch point of a touch screen gesture may be determined. Two or more links at the link area may be detected. A predicted link of the two or more links may be selected. An enlarged display of the predicted link may be previewed.

Other embodiments of this aspect include corresponding systems, apparatus, and computer programs, configured to perform the actions of the methods, encoded on computer storage devices. Further embodiments, features, and advantages, as well as the structure and operation of the various embodiments are described in detail below with reference to accompanying drawings.

### BRIEF DESCRIPTION OF THE FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 illustrates an example implementation of a link disambiguation system.

FIG. 2 illustrates a system for displaying links on a touch screen.

FIG. 3A is an example illustration of usage of the link disambiguation system of FIG. 1.

FIG. 3B is an example illustration of usage of the link disambiguation system of FIG. 1.

FIG. 4 illustrates an example of a method for displaying links on a touch screen.

### DETAILED DESCRIPTION

Embodiments are described herein with reference to illustrations for particular applications. It should be understood that the invention is not limited to the disclosed embodiments. Those skilled in the art with access to the teachings provided herein will recognize additional modifications, applications, and embodiments within the scope thereof and additional fields in which the embodiments would be of significant utility.

It would also be apparent to one of skill in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

A touch screen of a computing device may allow a user to scroll or interact with a document or application on the touch screen device using the user's finger(s). Selecting a link on a document to open or visit may require the user to tap the corresponding portion of the touch screen that is rendering the link. However, the portion of the document including the desired link may also include one or more other links that the user does not desire to activate or visit.

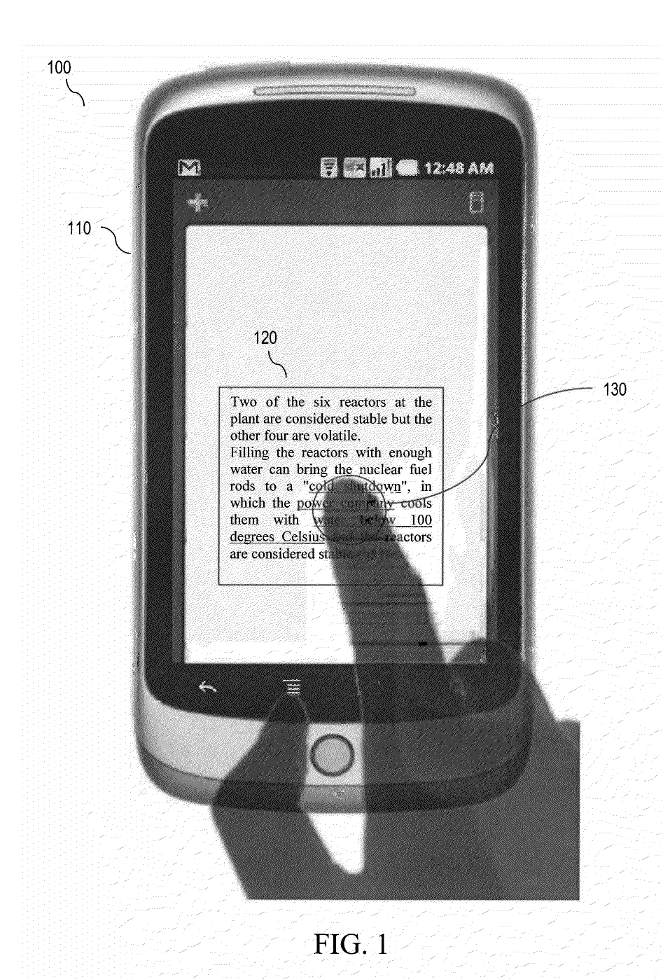

FIG. 1 shows an illustration 100 of a user using a touch screen of computing device 110. Based on the size of the text and links displayed on the touch screen, a user's finger may touch several links at the same time. For example, the circle in FIG. 1 illustrates a link area of uncertainty 130. Link selections in this link area are ambiguous and it is not clear what link will be selected. In a conventional touch screen system, a user may have no means of precisely selecting which of the links to activate. This may cause the user to accidentally activate the wrong link. As a manual workaround, a user may take the extra time and effort to manually increase the zoom (e.g., by pinching and expanding the user's fingers on the touch screen area) of this area of the document until the desired link is rendered large enough on the touch screen to enable a user to select the desired link without accidentally activating any of the other (undesired) links.

Link disambiguation methods and systems described in the embodiments herein enable a user to more precisely select one link of several closely situated links. According to one embodiment, a link disambiguation system may detect that a user has selected an area of a touch screen on which several links appear or exist, such as link area 130 of FIG. 1. Link area 130 may include links in the link area or near the link area. In some cases, users, device providers and software providers may adjust the size of the link area or the criteria for what links are included in the link area. These adjustments may be made based on past user activity.

The link disambiguation system then predicts which of the links the user most likely desired and present or preview that link to the user to confirm selection. The link disambiguation system enlarges and/or emphasizes the link, allowing for ease of user selection. For example, the font size of the link may be increased and/or highlighted. The user can then scroll or toggle amongst the links in link area 130 to select or activate one or more of the links.

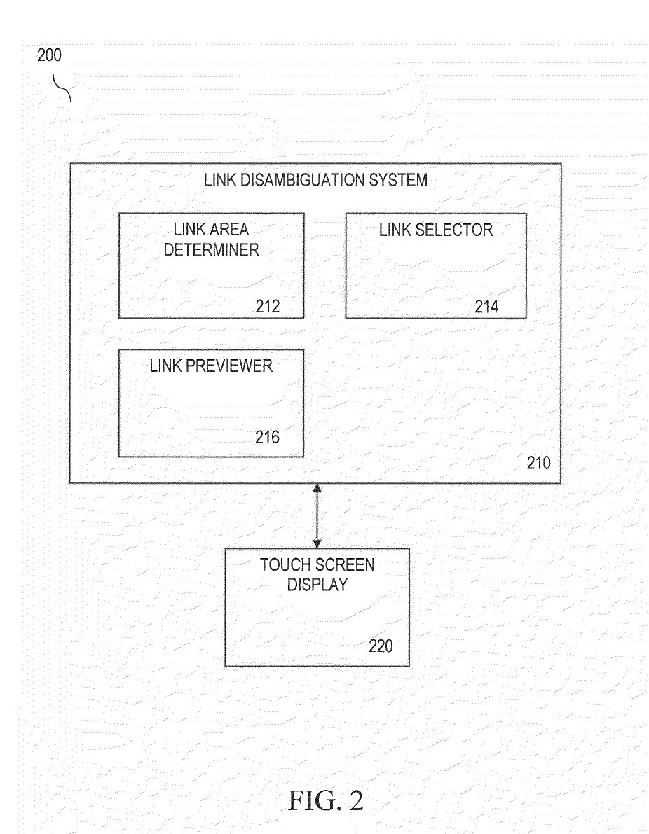

FIG. 2 illustrates an example system 200 for displaying links on a touch screen. System 200 includes link disambiguation system 210 and touch screen display 220. System 200 may be implemented on or with a computing device. For example, link disambiguation system 210 may be software, firmware, or hardware or any combination thereof in a computing device. A computing device can be any type of computing device having one or more processors. For example, a computing device can be a computer, server, workstation, mobile device (e.g., a mobile phone, personal digital assistant, navigation device, tablet, laptop or any other user carried device), game console, set-top box, remote control, kiosk, embedded system or other device having at least one processor and memory. A computing device may include a communication port or I/O device for communicating over wired or wireless communication link(s).

Computing devices such as a monitor, all-in-one computer, smartphone, tablet computer, remote control, etc., may include a touch screen display 220 that accepts user input via touching operations performed by a user's fingers or other instrument. For example purposes, a touch sensor grid may overlay the display area. The touch sensor grid contains many touch sensitive areas or cells which may be used to locate the area closest to the input of a user's touch.

Example touch operations using touch screen display 220 may include (but are not limited to) pinching, finger (or other stylus or object) touches, finger releases, and finger slides. The touch screen display 220 may include a screen or monitor that renders text and/or images such as the text area of portion 120. Portion 120 is not limited to areas of text, but may include images or text and images, whereby the text and/or images include one or more embedded links that a user may select for activation.

A user may be viewing a document, multimedia or portion of text, such as the text in portion 120 of FIG. 1. Portion 120 may include any kind of object that may be rendered on the touch screen, including text, images or video. As shown, portion 120 contains multiple links (which are indicated in portion 120 with underlining). The links include pointers or references to other objects, portions of a document and/or documents that may be activated by a user. For example, a user may select or activate a link by tapping on it with the user's finger. At this time, it is not clear to device 110 which link a user intended to select.

Link area determiner 212 determines an area of uncertainty at a touch point of a touch screen gesture, such as under a finger. For example, in response to a user selection or depression of a portion of the touch screen display 220 (e.g., with the user's finger), the link area determiner 212 may determine a radius, circumference or other perimeter area or other portion of the link area selected or desired by the user. In an example embodiment, link area determiner 212 may determine whether there is more than one link within the determined area of uncertainty. This area of uncertainty 130 arises when there are two or more possible links that the user may have desired. As may be seen in the example of FIG. 1, the link area of uncertainty 130 may include three possible intended selections of links from portion 120.

Link selector 214 predicts which of the links (from the area of uncertainty 130) the user intended to select. Link selector 214 implements any of a number of link prediction algorithms and/or sequences to use to make such a prediction. Example prediction techniques may include prediction based on past user activities, pressure sensitivity and/or location in a document.

A link to display may be predicted based on a user's past activity. For example, if a user has routinely selected the second link out of a plurality of closely situated links, then link selector 214 may predict the second link. In some cases, if the user has recently selected several links pertaining to “subject A,” then link selector 214 may predict the link that relates to “subject A.” Or for example, link selector 214 may determine from the touch screen where the concentration of pressure, based on the user's touch, is and predict the link most closely associated with the greatest pressure detection. In another example embodiment, the predicted link is selected based on sequential order of the links within the document (portion 120) and/or the area of uncertainty 130. Another possibility is that the predicted link actually is one of several links from the area of uncertainty 130 that may be emphasized or enlarged, whereby the user may select which of the links the user intended to activate.

If there is more than one link within the area of uncertainty (of portion 120), link previewer 216 displays a link preview of one or more of the links. In a further embodiment, link selector 214 predicts which of the links the user was likely selecting and provide that link as the primary link in the link preview. In another example embodiment, link previewer 216 provides a list of the links within the area of uncertainty arranged by their location within portion 120 (e.g., with the first link appearing first or at the top of a selectable list of links). According to a further embodiment, link selector 214 detects a change in pressure on a touch screen to allow a user to scroll amongst a plurality of links.

A user may scroll through the links of the portion 120, and as the user scrolls, link previewer 216 dynamically previews each selectable link. A tap of a finger or a release on one of the links of the preview may cause link previewer 216 to activate the associated link. Or for example, if the area of uncertainty only contains a single link, then link previewer 216 activates the selected link from the area of uncertainty.

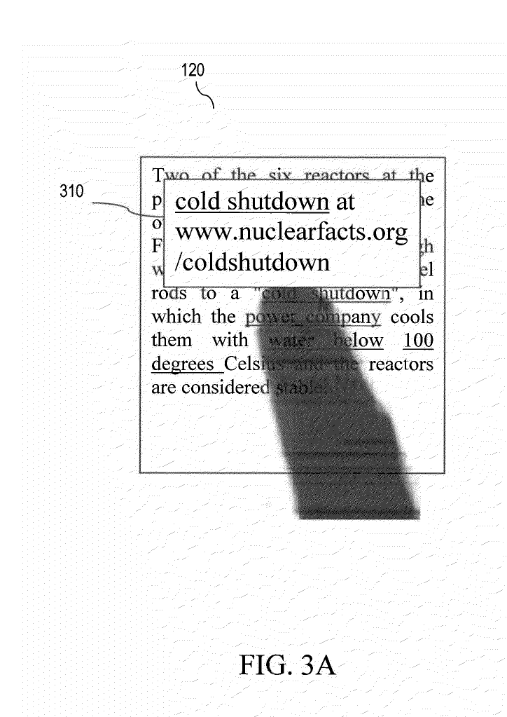

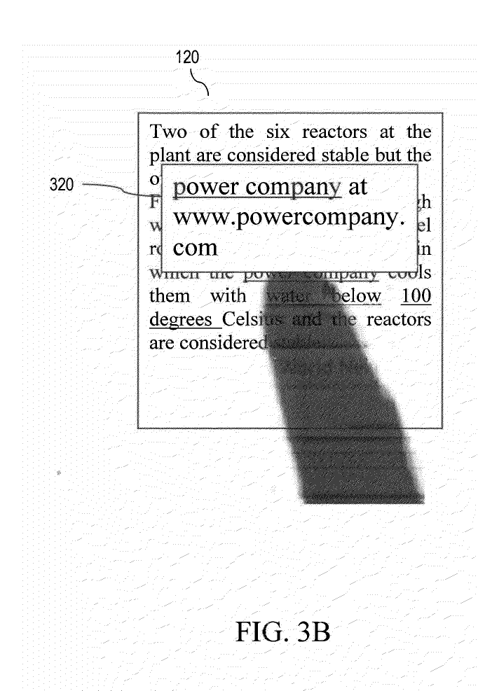

FIG. 3A is an example illustration of usage of the link disambiguation system 210. In the example of FIG. 3A, a link preview 310 of the text portion 120 is shown. Link preview 310 includes a link that was predicted by link selector 214 as being the selection of the user. In the example shown, link selector 214 predicted that the user intended to select the “cold shutdown” link.

Link preview 310 of FIG. 3A is an example implementation in which the word(s) that include or are associated with a link are displayed along with the address or universal resource locator (URL) of the link. Upon activation of the link, touch screen device 110 opens a new window or replaces the current document with the document or application associated with the link.

Link preview 310, as shown, includes a magnified, zoomed, enlarged or otherwise emphasized portion 120 corresponding to an area around the touch point of a screen gesture (e.g., where a finger or pressure is detected on the touch screen). The user may then view the link of preview 310 and more easily determine whether the user has selected the desired link or inadvertently selected another link that was situated in and/or near the area of uncertainty 130 of portion 120 where the user selection was received.

Link area determiner 212 determines, via a touch screen, that a user has touched or selected a text area of portion 120. Link area determiner 212 then determines whether there are two or more links within the area of uncertainty 130 (e.g., underneath and/or around the portion or area of the touch screen where the user selection or finger press was received or indicated) that the user may have intended to select. If there are multiple possible link selections in the area of uncertainty 130, as discussed above, link selector 214 predicts which of the links the user intended to select and present or preview them to the user in link preview 310.

In another example, link preview 310 includes any information rendered in any format that enables the user to determine whether or not the user selected the desired or intended link (or in other example embodiments, to allow the user to determine which link the user intended to select). For example, link preview 310 may include a list of the possible links that may appear within the link area of uncertainty. Then for example, the user may scan and select which of the links the user desires to activate. In another example, link preview 310 includes a confirmation box whereby the link disambiguation system 100 asks the user for confirmation as to whether the predicted link is the one which the user intended to select (e.g., with a “Did you mean . . . ?” type statement).

In another embodiment, link preview 310 includes information other than that which is rendered in the example of FIG. 3A. For example, link preview 310 may include only the text from portion 120, or just the address or URL associated with the link.

If the user did not intend to select a link that appears in link preview 310, then the user may scroll amongst the various links that appear in the area of uncertainty. For example, the user may perform a finger-swipe left, or finger-swipe right. A finger-swipe left may cause link previewer 216 to provide the previous link in link preview 310, while a finger-swipe right may cause the next link to be rendered or previewed in link preview 310. Other example embodiments may interpret other user gestures, such as finger swipes up or down to scroll through the previewed links.

FIG. 3B is an example illustration of usage of link disambiguation system 210. The example display of FIG. 3B shows the case when a user viewing link preview 310 scrolls or toggles to the next link in link area of uncertainty 130. As shown in the new link preview 320, the next link from link area 130 is rendered for confirmation of activation by the user. If for example, link preview 310 showed the last link (e.g., from the document and/or the area of uncertainty 130), then a finger-swipe right may cause link preview 320 to display the first link in the possible links, or no change at all (e.g., indicating there are no more subsequent links to select or scroll through from area of uncertainty 130).

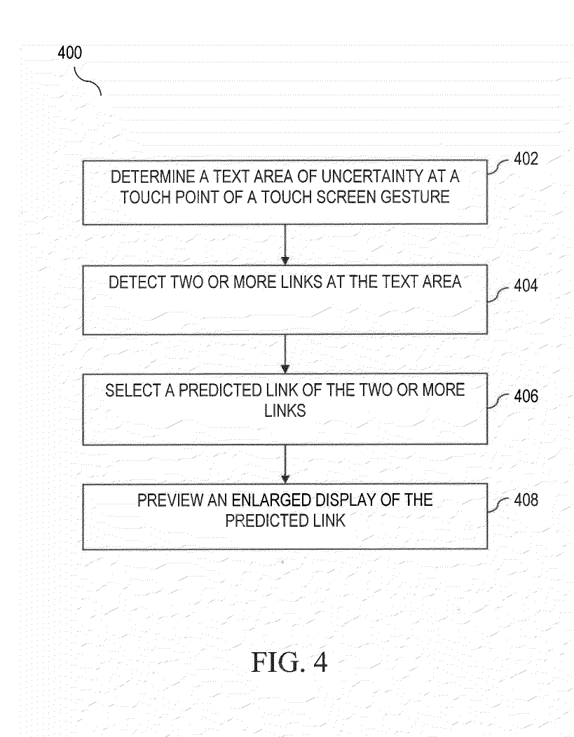

FIG. 4 is a flowchart illustrating an example method 400 for displaying links on a touch screen. At step 402, a link area of uncertainty at a touch point of a touch screen gesture is determined. For example, as shown in the figures, link area determiner 212 determines the link area of uncertainty 130 based on the touch of the finger on the touch screen display 220 of touch screen device 110. The touch point includes that portion of the touch screen 220 that received a touch screen gesture such as a finger press, pressure change, a swipe or other gesture.

At step 404, two or more links may be detected at the link area. For example, link area determiner 212 determines that there are two or more links within the area of uncertainty 130. In another embodiment, the link area of uncertainty 130 may be larger or smaller than shown in FIG. 1 and may be configured to include more or less links than shown in FIG. 1.

At step 406, a predicted link of the two or more links is selected. For example, link selector 214 predicts, from the example of FIG. 1, that the user intended to select “cold shutdown” as shown in FIG. 3A. In a further embodiment, link selector 214 or link previewer 216 may validate the predicted link to ensure that the validated link is a valid link and display it in link preview 310.

At step 408, an enlarged display of the predicted link is previewed. For example, the predicted link may have been for “cold shutdown” that appears in link preview 310. Link preview 310 includes an enlarged and/or otherwise enhanced display of portion 120 or link area 130. In another embodiment, a user may scroll amongst the links, and link preview 310 is updated as shown in link preview 320 of FIG. 3B. Link preview 310 may also display multiple links or link previews.

Embodiments may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The Summary and Abstract sections may set forth one or more but not all exemplary embodiments of the present invention as contemplated by the inventor(s), and thus, are not intended to limit the present invention and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer-implemented method for displaying links on a touch screen, comprising:
determining a link area of uncertainty at a touch point of a touch screen gesture;
detecting two or more links at the link area;
selecting a predicted link of the two or more links; and
previewing an enlarged display of the predicted link.

2. The method of claim 1, further comprising:
detecting a change in the touch screen gesture;
selecting a second predicted link of the two or more links based on the change of the gesture movement; and
previewing an enlarged display of the second predicted link.

3. The method of claim 2, wherein selecting a second predicted link is based on a change in a pressure location or a movement of the touch point.

4. The method of claim 1, wherein previewing an enlarged display includes highlighting the display of the predicted link.

5. The method of claim 1, wherein previewing an enlarged display includes increasing the font size of the predicted link.

6. The method of claim 1, wherein selecting the predicted link includes validating at least one of the two or more links and selecting a validated link.

7. The method of claim 1, wherein selecting the predicted link includes predicting the predicted link based on a location and pressure of the touch point of the touch screen gesture.

8. The method of claim 1, wherein detecting includes detecting uniform resource locator information for the two or more links.

9. The method of claim 1, wherein the selecting the predicted link includes predicting the predicted link based on past user activity.

10. A system for displaying links on a touch screen, comprising:
a link area determiner configured to determine a link area of uncertainty at a touch point of a touch screen gesture;
a link selector configured to
detect two or more links at the link area; and
select a predicted link of the two or more links; and
a link previewer configured to preview an enlarged display of the predicted link.

11. The system of claim 10, where
the link area determiner is further configured to detect a change in the touch screen gesture;
the link selector is further configured to select a second predicted link of the two or more links based on the change of the gesture movement; and
the link previewer is further configured to preview an enlarged display of the second predicted link.

12. The system of claim 11, wherein the link selector is further configured to select a second predicted link based on a change in a pressure location or a movement of the touch point.

13. The system of claim 10, wherein the link previewer is further configured to highlight the display of the predicted link.

14. The system of claim 10, wherein the link previewer is further configured to increase the font size of the predicted link.

15. The system of claim 10, wherein the link selector is further configured to validate at least one of the two or more links and select a validated link.

16. The system of claim 10, wherein the link previewer is further configured to predict the predicted link based on a location and pressure of the touch point of the touch screen gesture.

17. The system of claim 10, wherein the link area determiner is further configured to detect uniform resource locator information in a specified area.

18. The system of claim 10, wherein the link selector is further configured to predict the predicted link based on past user activity.

19. A computer program product comprising a computer readable storage medium having control logic stored therein that, when executed by a processor, causes the processor to display links on a touch screen, the control logic comprising:
a first computer readable program code to cause the processor to determine a link area of uncertainty at a touch point of a touch screen gesture;
a second computer readable program code to cause the processor to detect two or more links at the link area;
a third computer readable program code to cause the processor to select a predicted link of the two or more links; and
a fourth computer readable program code to cause the processor to preview an enlarged display of the predicted link.
